(19) United States
(12) Patent Application Publication
(10) Pub. No.: US 2017/0203528 A1
(43) Pub. Date: Jul. 20, 2017

(54) Mould Comprising Mobile Elements Which Are Obtained By Sintering

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Romain CALVEL, Clermont-Ferrand Cedex 9 (FR); Anthony GUEUGNEAU, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/327,947

(22) PCT Filed: Jun. 26, 2015
(86) PCT No.: PCT/FR2015/051735

§ 371 Date: Jan. 20, 2017

(30) Foreign Application Priority Data
Jul. 22, 2014 (FR) 1457063

(51) Int. Cl. B29D 30/06; B29C 33/38

(52) U.S. Cl. CPC B29D 30/0606; B29C 33/3842; B29D 2030/0613

(57) ABSTRACT

A mould comprises a lining, having a lining body (2), and at least one moulding element (1) that is articulated with respect to the lining body, a cylindrical part (10) constituting a rotation axis (X) and a moulding part (11) secured to the cylindrical part (10). The cylindrical part (10) is placed in a cylindrical hole (20) arranged in the lining body (2) made from the same material as the moulding element (1). The moulding element (1) is of one piece, and is non-separable from the lining body (2).

The present invention relates to mobile elements arranged in a lining. The lining is made up of all the moulding elements of the mould and the supports thereof. The mould will more particularly be a mould for the manufacture of tires.

In general, these mobile elements need to be mounted in the lining, which entails a specific step which lengthens the manufacturing process. This becomes the more critical when the components are small in size, because that entails meticulous adjustment which further increases the manufacturing time and, therefore, cost. It is also necessary to provide a system for holding the component in place in the lining in order to prevent it from escaping therefrom.

This mobile element may, for example, be a sipe blade which is mobile in order to facilitate demoulding. Several patents of the prior art have emphasized the problem of being able to demould sipe blades with significant undercuts, notably teardrop sipe blades, L-shaped sipe blades or Y-shaped sipe blades. There is therefore a need for mobility at the sipe blade itself, notably in order to facilitate demoulding. There is also a need for mobility between the sipe blade and the lining body, including a small degree of mobility to facilitate the demoulding of complex tread patterns having, for example, inclined sipes. There is also a need to modify the angle of the sipe blades (by setting the rotation, clamping, pinning, etc.) when it is found that the angle of the sipes in the tread pattern does not give the expected performance. Creation of the sipe blade is therefore a complex matter requiring assembly.

It is an object of the present invention to propose a mobile element that is manufactured in situ and that does not require specific assembly.

The mould according to the invention comprises a lining consisting of a lining body and of at least one moulding element that is articulated with respect to the lining body, the said body comprising a cylindrical part constituting a rotation axis X and a moulding part secured to the cylindrical part; it is characterized in that the cylindrical part is placed in a cylindrical hole arranged in the lining body made from the same material as the moulding element, and in that the said moulding element is of one piece. The moulding element is produced in situ as a single piece namely all in one component, and is not separable from the lining body.

Advantageously, the mould comprises means for the abutment and/or immobilization of the moulding element. The mobile element can thus turn between two or more positions according to the type of articulation provided and/or can be immobilized in the position desired.

Advantageously, the lining body has a surface arranged inside the mould and one of the abutments is perpendicular to the surface of the lining body and the other is inclined. Because the mould has a rounded profile, this allows the moulding of the rubber in the mould, the moulding element is then an inclined position and that then facilitates demoulding since the moulding element can position itself in the direction of demoulding, namely perpendicular to the surface of the mould.

According to a first alternative form, the cylindrical hole of the lining body and the cylindrical part of the moulding element have a circular profile. The mobile element can thus turn freely on its axis.

According to a second alternative form, the cylindrical hole of the lining body and the cylindrical part of the moulding element have an oval profile. The mobile element thus has a limited degree of travel.

According to one particular arrangement, the moulding element is arranged at the end of a sipe blade and this end has a cylindrical exterior shape. Thus, the moulding element can rotate about the end of the sipe blade. The sipe blade thus has one end articulated and allows a greater number of shapes.

Advantageously, the cylindrical hole of the lining body has a closed profile and the moulding element has a longitudinal recess in which a cylindrical part of the lining body is inserted. The cylindrical part of the moulding element is thus trapped in the lining body.

According to another arrangement, the cylindrical element is extended on each side by a cylindrical spigot that acts as a hinge. This spigot collaborates with a cylindrical recess in the continuation of the cylindrical hole so as to hold the moulding element and allow it to rotate.

Advantageously, the sipe blade comprises several moulding elements. This then yields a sipe blade that has elements that are mobile so as to create different shapes in the rubber, such as T-shapes, Y-shapes or teardrop shapes, the fact that it is articulated allowing for demoulding. It is thus possible to obtain grooves of more complex shape which are easier to demould.

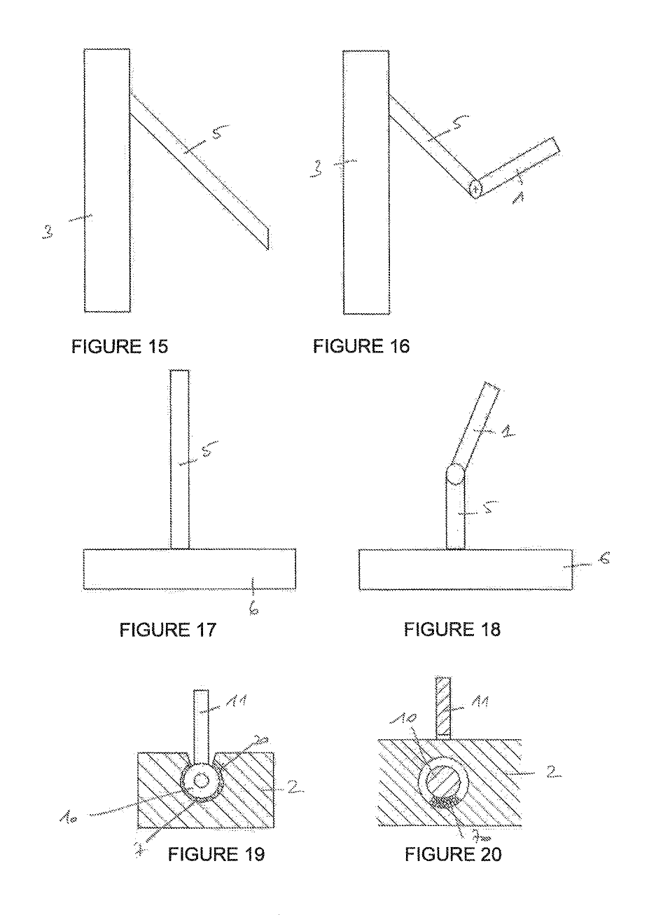

According to one embodiment, the sipe blade has a length and a height, and the moulding part of the moulding element is placed parallel to the length of the sipe blade, namely in the lengthwise direction. In this way, the mobile element moves in the continuation of the said sipe blade. That allows another tread pattern geometry for example to be tested (cf. FIGS. 15 and 16 in plan view from above).

Advantageously, the sipe blade has a length and a height and the rectilinear part of the moulding element is placed perpendicular to the length of the sipe blade, namely in the heightwise direction. In this way, the mobile element will move in the height of the said sipe blade. That allows demoulding to be made easier or allows the testing of another geometry depthwise in the rubber by incorporating an immobilizing system (cf. FIGS. 17 and 18 in side view).

The method of manufacturing an articulated moulding element with at least one of the above features is characterized in that the lining body and the moulding element are produced as a single piece by powder laser sintering. Laser sintering makes it possible to create mobility in a single piece. The laser sintering is performed with a clearance between the components, the clearance being small enough to allow a small amount of attachment between the two moving parts but large enough that detachment can be achieved easily by pulling on the mobile part; the clearance is between 0.05 and 0.5 mm. The powder is either trapped between the two components and blown in order to remove it, or is semi-fused at the bottom (usually because of gravity) through the diffusion of heat in the clearance between the two components during the sintering, and the mobility is freed by breaking the semi-fused particles through action on the moulding element.

Advantageously, an at least 0.1 mm thickness of non-fused powder is left between the articulated moulding element and the lining or lining element. The space in which the powder is not fused by laser sintering leaves an empty space between the components which are thus able to move relative to one another. The thickness of 0.1 mm is enough that if one part is fused the link will be weak enough to break easily when an attempt is made to move one of the components.

Still other advantages may become apparent to a person skilled in the art from reading the examples given hereinbelow, illustrated by the attached figures, given by way of example:

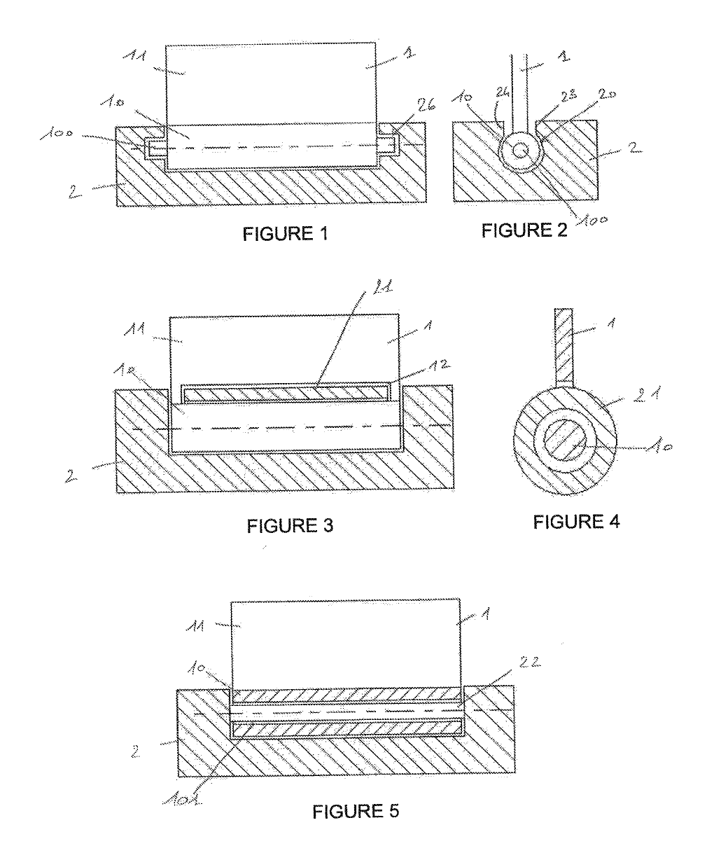

FIG. 1 depicts a view in longitudinal section of an articulated moulding element according to the invention,

FIG. 2 is a view in transverse section of the articulated moulding element of FIG. 1,

FIG. 3 is a view in cross section of an articulated moulding element according to a second alternative form of the invention,

FIG. 4 is a view in transverse section of the articulated moulding element of FIG. 3,

FIG. 5 is a view in cross section of an articulated moulding element according to a third alternative form of the invention,

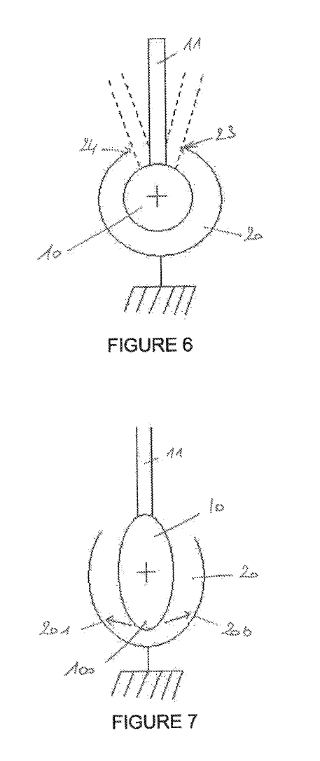

FIG. 6 is a schematic view of a first alternative form of limiting of the moulding element according to the invention,

FIG. 7 depicts a schematic view of a second alternative form of limiting of the moulding element according to the invention,

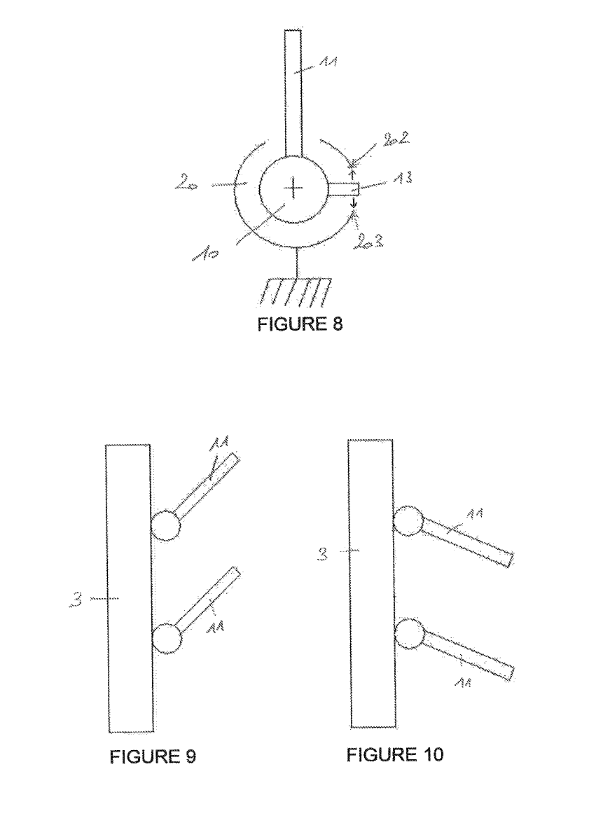

FIG. 8 is a schematic view of a third alternative form of limiting of the moulding element according to the invention,

FIGS. 9 and 10 are two examples of positions of the moulding element according to the invention,

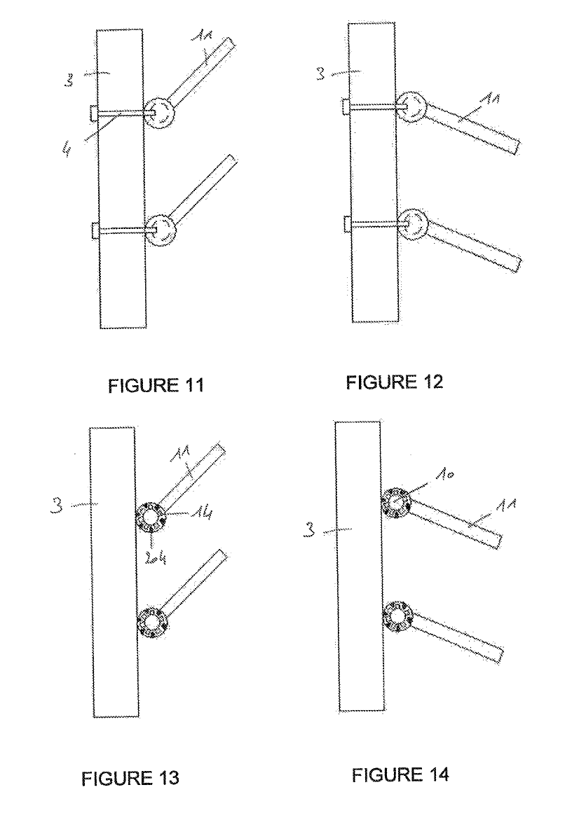

FIGS. 11 and 12 are two examples of positions of the moulding element according to the invention with a first example of an immobilizing system,

FIGS. 13 and 14 are two examples of positions of the moulding element according to the invention with a second example of an immobilizing system,

FIGS. 15 and 16 are views from above along the length of the sipe blade,

FIGS. 17 and 18 are views along the height of the sipe blade,

FIG. 19 is a view in transverse section of the moulding element manufactured according to the method,

FIG. 20 is a view in transverse section of another type of moulding element,

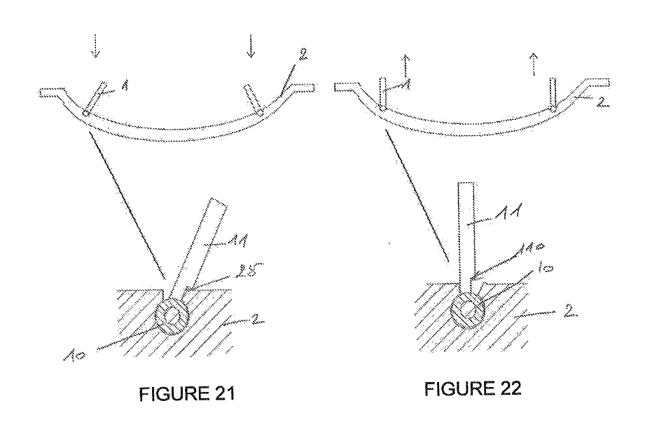

FIG. 21 is a view in profile of a mould with detail of a sipe blade in the mould-filling position,

FIG. 22 is a view in profile of the mould of FIG. 21 with the detail of the sipe blade in the demoulding position.

The example illustrated in FIGS. 1 and 2 shows a lining comprising an articulated moulding element 1 and a lining body 2 in which a cylindrical hole 20 is pierced. The moulding element 1 comprises a cylindrical part 10 arranged in the cylindrical hole 20 and a moulding part 11 which in this instance is rectilinear, starting from the cylindrical part 10. The cylindrical part 10 rotates about an axis X and on each side has cylindrical spigots 100 acting as a hinge and each collaborating with an orifice 26 that extends the cylindrical hole 20.

The example of FIGS. 3 and 4 shows an articulated moulding element in which the moulding part 11 has a recess 12 in which a peripheral part 21 of the lining body 2 can slide.

In the example of FIG. 5, the moulding element 1 has a cylindrical part 10 pierced with a hole 101 in which a rod 22 of axis X is inserted and secured to the lining 2.

In FIG. 6, the rectilinear part 11 is halted between two abutment stops 23 and 24 arranged on a surface of the lining 2 that is arranged on the interior side of the mould.

In FIG. 7, the cylindrical hole 20 of the lining body 2 and the cylindrical part 10 of the moulding element 1 have an oval profile and so when the moulding element 1 turns, the longest part 100 of the cylindrical part 10 will come into abutment against two sides 200 and 201 of the cylindrical hole 20.

In FIG. 8, the moulding element 1 has a counter abutment stop 13 which will be halted by two abutment stops 202 and 203 positioned inside the cylindrical hole 20. For better retention, it is possible to conceive of several abutment stops and counter abutment stops in the manner of meshing gears or a splined shaft.

FIGS. 9 to 18 show how the invention can be used in a tire manufacturing mould.

FIG. 9 illustrates an example of a position of the mobile element 1 on a moulding bar 3 for creating a tire groove, the moulding part 11 of the moulding element 1 in this instance is a sipe blade for moulding a sipe in the said tire. FIG. 10 shows a second position of the moulding element 1.

As in FIG. 9, in FIGS. 11 and 12, each mobile element 1 is prevented from rotating by a pin 4.

Likewise in FIGS. 13 and 14, the moulding elements 1 have teeth 14 which are equivalent to counter abutment stops, distributed over the entire periphery of the cylindrical part 10, these collaborating with abutment stops 204 arranged in the cylindrical hole 20, all of this constituting meshing gears or a splined shaft which may have the ability to slide so that the sipe blade can be removed and then reintroduced at another angle of inclination that will allow immobilization of the moulding part 11 of the moulding element 1.

FIG. 15 shows a plan view from above of the moulding bar 3 in the mould with a sipe blade 5 produced in the conventional way. FIG. 16 illustrates an articulated moulding element 1 placed at the end of the sipe blade 5. In this way, the tread pattern of the tire will be able to have sipes that follow broken lines and the tread pattern will be able to be modified during tire manufacture, with an immobilizing system.

FIG. 17 shows, in cross section, a bottom of the lining body 2 with a sipe blade 5 arranged on this bottom in the conventional way. In FIG. 18, the sipe blade 5 is surmounted by an articulated moulding element 1 placed at the upper part. It is thus easier to demould the tire since the mobile element 1 affords a certain degree of flexibility to the upper part of the sipe blade 5. The sipe blade may comprise one or more mobile elements so as to create an L-shaped sipe or a Y-shaped sipe which are shapes that are already known.

Manufacture of the moulding element 1 on the lining body 2 is performed in a single piece by powder laser sintering. In FIG. 19, the cylindrical part 10 is for exemple approximately 0.2 mm distant from the cylindrical hole 20, so powder 7 remains trapped between the cylindrical part 10 and the cylindrical hole 20 of the lining body after the laser sintering operation has been performed and this powder is then blown out in order to obtain the articulated moulding element 1.

It is also possible to have some of the powder semi-fused through the diffusion of heat, here near the bottom of the space between the two components, this powder constituting a slender connection 70 which connects the cylindrical part 10 to the inside of the cylindrical hole 20. This slender connection 70 is broken through action on the moulding element 1. In the example illustrated in FIG. 20, when the clearance is too small, during the sintering through diffusion of heat the connection is at the bottom because of gravity and this makes the mobile element rest on the bottom of the cylindrical cavity.

FIG. 21 shows an example of a mould with its lining which in this instance comprises two moulding elements 1 at the time of moulding. As can be seen, the mould has a rounded shape and the moulding elements 1 are, for example, perpendicular to the surface of the lining at the time of moulding since the tread patterns are perpendicular (which is not necessarily always the case) to the surface of the tire. The pressure exerted on the sipe blades at the time of the moulding of the rubber is great which means that the moulding parts 11 of the moulding elements 1 are pushed into an inclined position (into abutment), a cutout 110 being provided, for example, on one side of the moulding part 11 so as to limit the inclination of the moulding element 1. This cutout 110 collaborates with, for example, an elevation 25 of the surface of the lining 2.

FIG. 22 shows the mould of FIG. 21 at the time of demoulding. Once the rubber has hardened or become vulcanized, because demoulding is performed in a movement perpendicular to the mould rather than to the rounded surface of the lining, the moulding element 1 will rotate in the demoulding direction to make such demoulding easier, which means to say in this instance will rotate to vertical.

Other applications of the mobile element 1 are possible without departing from the scope of the present invention.

1. A mould comprising a lining, having a lining body, and at least one moulding element that is articulated with respect to the lining body, said moulding element comprising a cylindrical part constituting a rotation axis and a moulding part secured to the cylindrical part, wherein the cylindrical part is placed in a cylindrical hole arranged in the lining body made from the same material as the moulding element, and wherein said moulding element is of one piece.

2. The mould according to claim 1, comprising means for the abutment and/or immobilization of the moulding element.

3. The mould according to claim 2, wherein the lining body has a surface arranged inside the mould and wherein one of the abutments is perpendicular to the surface of the lining body and the other is inclined.

4. The mould according to claim 1, wherein the cylindrical hole and the cylindrical part of the moulding element have a circular profile.

5. The mould according to claim 1, wherein the cylindrical hole and the cylindrical part of the moulding element have an oval profile.

6. The mould according to claim 1, characterized in that wherein the moulding element is arranged at the end of a sipe blade and wherein this end has a cylindrical exterior shape.

7. The mould according to claim 1, wherein the cylindrical hole has a closed profile and wherein the moulding element has a longitudinal recess in which a cylindrical part of the lining body is inserted.

8. The mould according to claim 1, wherein the cylindrical element is extended on each side by a cylindrical spigot that acts as a hinge.

9. A method of manufacturing an articulated moulding element of a mould according to claim 1, wherein the moulding element and the lining body are produced as a single piece by powder laser sintering during one and the same manufacturing operation and form a non-separable connection.

10. The method of manufacture according to claim 9, wherein an at least 0.1 mm thickness of non-fused powder is left between the articulated moulding element and the lining body.
